(19) United States
(12) Patent Application Publication
(10) Pub. No.: US 2025/0087704 A1
(43) Pub. Date: Mar. 13, 2025

(54) High Speed Formation Of Cells For Configuring Anisotropic Expansion Of Silicon-Dominant Anodes

(71) Applicant: Enevate Corporation, Irvine, CA (US)

(72) Inventors: Jill Renee Pestana, Long Beach, CA (US); Benjamin Park, Mission Viejo, CA (US); Frederic Bonhomme, Lake Forest, CA (US); Giulia Canton, Irvine, CA (US); Ian Browne, Orange, CA (US)

(21) Appl. No.: 18/773,938

(22) Filed: Jul. 16, 2024

Related U.S. Application Data
(63) Continuation of application No. 16/676,802, filed on Nov. 7, 2019, now abandoned.

(51) Int. Cl. H01M 4/66; H01M 4/02; H01M 4/04; H01M 4/38; H01M 10/0525

(52) U.S. Cl. CPC H01M 4/661; H01M 4/0435; H01M 4/386; H01M 10/0525; H01M 2004/021

(57) ABSTRACT

Systems and methods for high speed formation of cells for configuring anisotropic expansion of silicon-dominant anodes may include a cathode, an electrolyte, and an anode, where the anode may include a current collector and an active material on the current collector. An expansion of the anode may be configured by a charge rate during formation of the battery. The expansion of the anode may be less than 1.5% in lateral dimensions of the anode for higher charge rates during formation with the active material being more than 50% silicon, where the higher charge rate may be 1 C or higher, and perpendicular expansion may be higher for charge rates below 1 C during formation. The expansion of the anode may be lower in lateral dimensions for thicker current collectors, which may be 10 μm or thicker, and may be lower in lateral dimensions for more rigid materials for the current collector.

### CLAIM OF PRIORITY AND CROSS-REFERENCE TO RELATED APPLICATIONS/INCORPORATION BY REFERENCE

This application is a continuation of U.S. patent application Ser. No. 16/676,802 filed on Nov. 7, 2019, which is hereby incorporated by reference in its entirety.

### FIELD

Aspects of the present disclosure relate to energy generation and storage. More specifically, certain embodiments of the disclosure relate to a method and system for high speed formation of cells for configuring anisotropic expansion of silicon-dominant anodes.

### BACKGROUND

Conventional approaches for battery anodes may be costly, cumbersome, and/or inefficient—e.g., they may be complex and/or time consuming to implement, and may limit battery lifetime.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

A system and/or method for high speed formation of cells for configuring anisotropic expansion of silicon-dominant anodes, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a diagram of a battery with configured anode expansion, in accordance with an example embodiment of the disclosure.

FIG. 2 illustrates anode expansion during lithiation, in accordance with an example embodiment of the disclosure.

FIG. 3 shows top and side views of a cell, in accordance with an example embodiment of the disclosure.

FIG. 4 is a flow diagram of a process for configured expansion in a silicon anode, in accordance with an example embodiment of the disclosure.

FIG. 5 is a flow diagram of an alternative process for configured expansion in a silicon anode, in accordance with an example embodiment of the disclosure.

FIG. 6 illustrates expansion of various anodes for different formation charge rates, in accordance with an example embodiment of the disclosure.

FIG. 7 illustrates discharge capacity during cycling of cells with different formation rates, in accordance with an example embodiment of the disclosure.

FIG. 8 illustrates expansion rates for anodes subjected to different formation processes, in accordance with an example embodiment of the disclosure.

### DETAILED DESCRIPTION

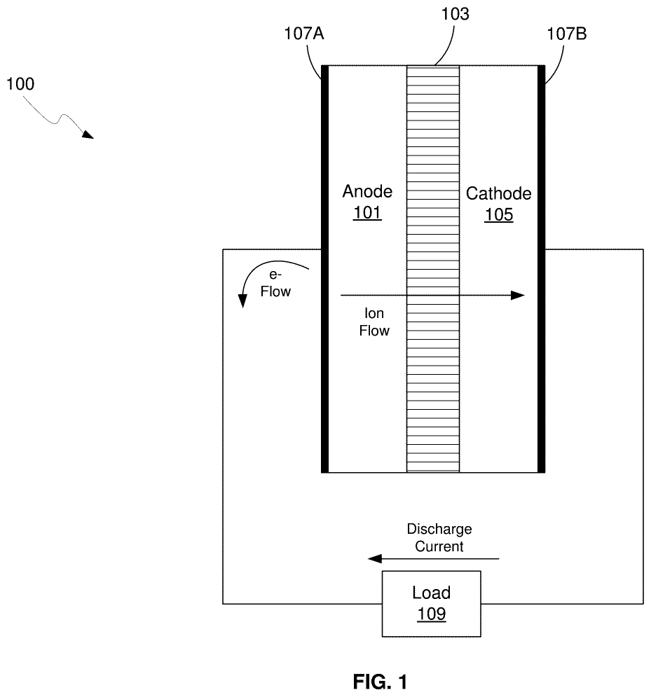

FIG. 1 is a diagram of a battery with configured anode expansion, in accordance with an example embodiment of the disclosure. Referring to FIG. 1, there is shown a battery 100 comprising a separator 103 sandwiched between an anode 101 and a cathode 105, with current collectors 107A and 107B. There is also shown a load 109 coupled to the battery 100 illustrating instances when the battery 100 is in discharge mode. In this disclosure, the term “battery” may be used to indicate a single electrochemical cell, a plurality of electrochemical cells formed into a module, and/or a plurality of modules formed into a pack.

The development of portable electronic devices and electrification of transportation drive the need for high performance electrochemical energy storage. Small-scale (<100 Wh) to large-scale (>10 KWh) devices primarily use lithium-ion (Li-ion) batteries over other rechargeable battery chemistries due to their high-performance.

The anode 101 and cathode 105, along with the current collectors 107A and 107B, may comprise the electrodes, which may comprise plates or films within, or containing, an electrolyte material, where the plates may provide a physical barrier for containing the electrolyte as well as a conductive contact to external structures. In other embodiments, the anode/cathode plates are immersed in electrolyte while an outer casing provides electrolyte containment. The anode 101 and cathode are electrically coupled to the current collectors 107A and 107B, which comprise metal or other conductive material for providing electrical contact to the electrodes as well as physical support for the active material in forming electrodes.

The configuration shown in FIG. 1 illustrates the battery 100 in discharge mode, whereas in a charging configuration, the load 109 may be replaced with a charger to reverse the process. In one class of batteries, the separator 103 is generally a film material, made of an electrically insulating polymer, for example, that prevents electrons from flowing from anode 101 to cathode 105, or vice versa, while being porous enough to allow ions to pass through the separator 103. Typically, the separator 103, cathode 105, and anode 101 materials are individually formed into sheets, films, or active material coated foils. Sheets of the cathode, separator and anode are subsequently stacked or rolled with the separator 103 separating the cathode 105 and anode 101 to form the battery 100. In some embodiments, the separator 103 is a sheet and generally utilizes winding methods and stacking in its manufacture. In these methods, the anodes, cathodes, and current collectors (e.g., electrodes) may comprise films.

In an example scenario, the battery 100 may comprise a solid, liquid, or gel electrolyte. The separator 103 preferably does not dissolve in typical battery electrolytes such as compositions that may comprise: Ethylene Carbonate (EC), Fluoroethylene Carbonate (FEC), Propylene Carbonate (PC), Dimethyl Carbonate (DMC), Ethyl Methyl Carbonate (EMC), Diethyl Carbonate (DEC), etc. with dissolved LiBF₄, LiAsF₆, LiPF₆, and LiClO₄ etc. The separator 103 may be wet or soaked with a liquid or gel electrolyte. In addition, in an example embodiment, the separator 103 does not melt below about 100 to 120° C., and exhibits sufficient mechanical properties for battery applications. A battery, in operation, can experience expansion and contraction of the anode and/or the cathode. In an example embodiment, the separator 103 can expand and contract by at least about 5 to 10% without failing, and may also be flexible.

The separator 103 may be sufficiently porous so that ions can pass through the separator once wet with, for example, a liquid or gel electrolyte. Alternatively (or additionally), the separator may absorb the electrolyte through a gelling or other process even without significant porosity. The porosity of the separator 103 is also generally not too porous to allow the anode 101 and cathode 105 to transfer electrons through the separator 103.

The anode 101 and cathode 105 comprise electrodes for the battery 100, providing electrical connections to the device for transfer of electrical charge in charge and discharge states. The anode 101 may comprise silicon, carbon, or combinations of these materials, for example. Typical anode electrodes comprise a carbon material that includes a current collector such as a copper sheet. Carbon is often used because it has excellent electrochemical properties and is also electrically conductive. Anode electrodes currently used in rechargeable lithium-ion cells typically have a specific capacity of approximately 200 milliamp hours per gram. Graphite, the active material used in most lithium ion battery anodes, has a theoretical energy density of 372 milliamp hours per gram (mAh/g). In comparison, silicon has a high theoretical capacity of 4200 mAh/g. In order to increase volumetric and gravimetric energy density of lithium-ion batteries, silicon may be used as the active material for the cathode or anode. Silicon anodes may be formed from silicon composites, with more than 50% silicon, for example.

In an example scenario, the anode 101 and cathode 105 store the ion used for separation of charge, such as lithium. In this example, the electrolyte carries positively charged lithium ions from the anode 101 to the cathode 105 in discharge mode, as shown in FIG. 1 for example, and vice versa through the separator 105 in charge mode. The movement of the lithium ions creates free electrons in the anode 101 which creates a charge at the positive current collector 107B. The electrical current then flows from the current collector through the load 109 to the negative current collector 107A. The separator 103 blocks the flow of electrons inside the battery 100, allows the flow of lithium ions, and prevents direct contact between the electrodes.

While the battery 100 is discharging and providing an electric current, the anode 101 releases lithium ions to the cathode 105 via the separator 103, generating a flow of electrons from one side to the other via the coupled load 109. When the battery is being charged, the opposite happens where lithium ions are released by the cathode 105 and received by the anode 101.

The materials selected for the anode 101 and cathode 105 are important for the reliability and energy density possible for the battery 100. The energy, power, cost, and safety of current Li-ion batteries need to be improved in order to, for example, compete with internal combustion engine (ICE) technology and allow for the widespread adoption of electric vehicles (EVs). High energy density, high power density, and improved safety of lithium-ion batteries are achieved with the development of high-capacity and high-voltage cathodes, high-capacity anodes and functionally non-flammable electrolytes with high voltage stability and interfacial compatibility with electrodes. In addition, materials with low toxicity are beneficial as battery materials to reduce process cost and promote consumer safety.

The performance of electrochemical electrodes, while dependent on many factors, is largely dependent on the robustness of electrical contact between electrode particles, as well as between the current collector and the electrode particles. The electrical conductivity of silicon anode electrodes may be manipulated by incorporating conductive additives with different morphological properties. Carbon black (SuperP), vapor grown carbon fibers (VGCF), and a mixture of the two have previously been incorporated separately into the anode electrode resulting in improved performance of the anode. The synergistic interactions between the two carbon materials may facilitate electrical contact throughout the large volume changes of the silicon anode during charge and discharge.

State-of-the-art lithium-ion batteries typically employ a graphite-dominant anode as an intercalation material for lithium. With demand for lithium-ion battery performance improvements such as higher energy density and fast-charging, silicon is being added as an active material or even completely replacing graphite as a dominant anode material. Most electrodes that are considered “silicon anodes” in the industry are graphite anodes with silicon added in small quantities (typically <20%). These graphite-silicon mixture anodes must utilize the graphite, which has a lower lithiation voltage compared to silicon; the silicon has to be nearly fully lithiated in order to utilize the graphite. Therefore, these electrodes do not have the advantage of a silicon or silicon composite anode where the voltage of the electrode is substantially above 0V vs Li/Li+ and thus are less susceptible to lithium plating. Furthermore, these electrodes can have significantly higher excess capacity on the silicon versus the opposite electrode to further increase the robustness to high rates.

Silicon-based anodes have a lithiation/delithiation voltage plateau at about 0.3-0.4V vs. Li/Li+, which allows it to maintain an open circuit potential that avoids undesirable Li plating and dendrite formation. While silicon shows excellent electrochemical activity, achieving a stable cycle life for silicon-based anodes is challenging due to silicon's large volume changes during lithiation and delithiation. Silicon regions may lose electrical contact from the anode as large volume changes coupled with its low electrical conductivity separate the silicon from surrounding materials in the anode.

In addition, the large silicon volume changes exacerbate solid electrolyte interphase (SEI) formation, which can further lead to electrical isolation and, thus, capacity loss. Expansion and shrinkage of silicon particles upon charge-discharge cycling causes pulverization of silicon particles, which increases their specific surface area. As the silicon surface area changes and increases during cycling, SEI repeatedly breaks apart and reforms. The SEI thus continually builds up around the pulverizing silicon regions during cycling into a thick electronic and ionic insulating layer. This accumulating SEI increases the impedance of the electrode and reduces the electrode electrochemical reactivity, which is detrimental to cycle life.

A solution to the expansion of anodes is to configure the expansion that occurs during lithiation by a specific formation of the cell. Formation is a step in the production process of lithium-ion batteries. This step typically occurs in manufacturing before delivery of cells to a customer and typically involves applying current to the cell in such a way that causes lithium to be inserted into the anode. This first “charge” causes the system to undergo reversible and irreversible reactions. To ensure stability, it is desirable to control the reactions to ensure that the interface formed between electrodes and electrolyte (SEI) is controlled and any gasses formed are expelled in a process called degassing. The temperature can be increased to increase reaction kinetics in some cases.

In the disclosed silicon-dominant anode cells, the design is such that the anode is not fully utilized; the anodes have excess capacity and are higher in voltage, which gives them an advantage over other silicon anodes. Silicon, however, expands substantially more than graphite when lithiated, which causes instabilities in the SEI, silicon particles, and overall cell upon delithiation and repeat cycling. In general, the stress of silicon lithiation is absorbed by expansion of the cell materials. Furthermore, use of thinner current collectors for a given cell design will result in higher x-y expansion due to increased stress in the current collector (same expansion force, lower cross-sectional area). In some cases, excessive expansion can cause the current collectors to tear, leading to cell failure. This behavior limits the minimum current collector thickness which may be used. Since formation initiates the first expansion and SEI layer growth of silicon, tuning formation charge rate to optimize different phenomena, such as SEI composition, thickness, and homogeneity on the anode, is a promising direction to improve cycle performance of a cell with silicon-dominant anodes.

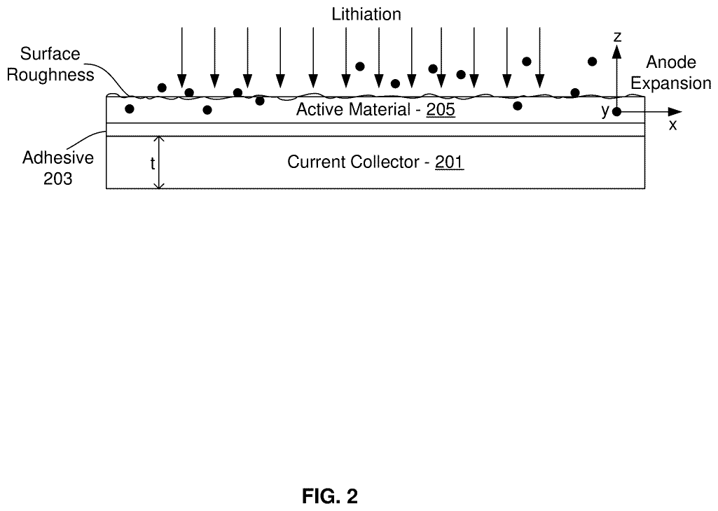

FIG. 2 illustrates anode expansion during lithiation, in accordance with an example embodiment of the disclosure. Referring to FIG. 2, there are shown a current collector 201, adhesive 203, and an active material 205. It should be noted that the adhesive 203 may or may not be present depending on the type of anode fabrication process utilized, as the adhesive is not necessarily present in a direct coating process. In an example scenario, the active materials comprises silicon particles in a binder material and a solvent, where the active material is pyrolyzed to turn the binder into a glassy carbon that provides a structural framework around the silicon particles and also provides electrical conductivity. The active material may be coupled to the current collector 201 using the adhesive 203. The current collector 201 may comprise a metal film, such as copper, nickel, or titanium, for example, although other conductive foils may be utilized depending on desired tensile strength.

FIG. 2 also illustrates lithium ions impinging upon and lithiating the active material 205 when incorporated into a cell with a cathode, electrolyte, and separator (not shown). The lithiation of silicon-dominant anodes causes expansion of the material, where horizontal expansion is represented by the x and y axes, and thickness expansion is represented by the z-axis, as shown. The current collector 201 has a thickness t, where a thicker foil provides greater strength and providing the adhesive 203 is strong enough, restricts expansion in the x- and y-directions, resulting in greater z-direction expansion, thus anisotropic expansion. Example thicker foils may be greater than 10 μm thick, such as 20 μm for copper, for example, while thinner foils may be less than 10 μm, such as 5-6 μm thick or less for copper.

In another example scenario, when the current collector 201 is thinner, on the order of 5-6 μm or less for a copper foil, for example, the active material 205 may expand more easily in the x- and y-directions, although still even more easily in the z-direction without other restrictions in that direction. In this case, the expansion is anisotropic, but not as much as compared to the case of higher x-y confinement.

In addition, different materials with different tensile strength may be utilized to configure the amount of expansion allowed in the x- and y-directions. For example, nickel is a more rigid, mechanically strong metal for the current collector 201, and as a result, nickel current collectors confine x-y expansion when a strong enough adhesive is used. In this case, the expansion in the x- and y-directions may be more limited, even when compared to a thicker copper foil, and result in more z-direction expansion, i.e., more anisotropic. In anodes formed with 5 μm nickel foil current collectors, very low expansion and no cracking results. Furthermore, different alloys of metals may be utilized to obtain desired thermal conductivity, electrical conductivity, and tensile strength, for example.

In an example scenario, in instances where adhesive is utilized, the adhesive 203 comprises a polymer such as polyimide (PI) or polyamide-imide (PAI) that provides adhesive strength of the active material film 205 to the current collector 201 while still providing electrical contact to the current collector 201. Other adhesives may be utilized depending on the desired strength, as long as they can provide adhesive strength with sufficient conductivity following processing. If the adhesive 203 provides a stronger, more rigid bond, the expansion in the x- and y-directions may be more restricted, assuming the current collector is also strong. Conversely, a more flexible and/or thicker adhesive may allow more x-y expansion, reducing the anisotropic nature of the anode expansion.

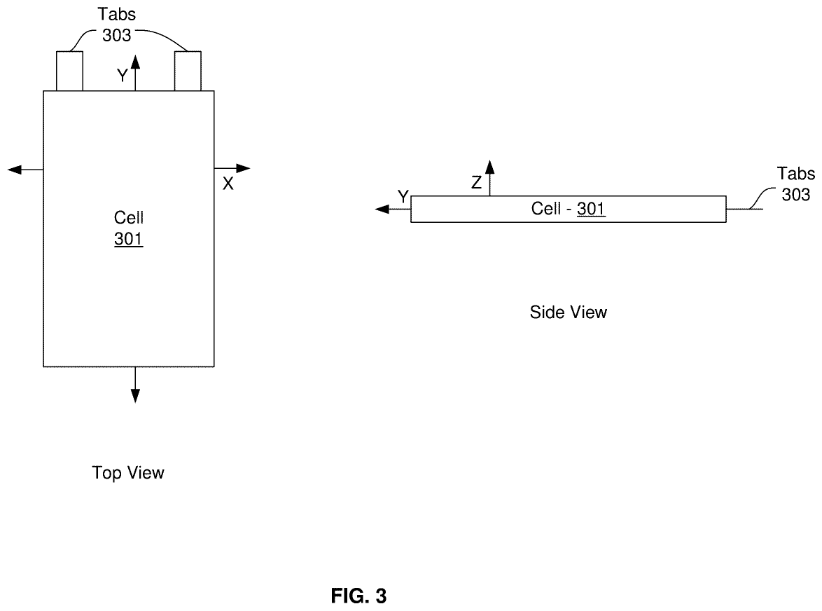

As stated above, the formation process may be utilized to configure the expansion of the anode during lithiation. A higher charge rate during formation may configure the expansion of the anode to be higher in the z-direction and lower in the x-y directions. Higher charge rates may comprise 1C, 4C, 7C, or higher, for example. Conversely, a lower charge rate during formation may configure expansion of the anode during lithiation to be lower in the z-direction and higher in the x-y directions. Lower charge rates may comprise C/40, C/20, C/2, for example. It may be desirable to configure the cell with higher expansion in one direction versus the other direction based on the type of cell packaging, for example, as shown with respect to FIG. 3.

FIG. 3 shows top and side views of a cell, in accordance with an example embodiment of the disclosure. Referring to FIG. 3, there is shown cell 301 with foil tabs 303 for providing contact to the anode and cathode within the cell 301. The cell 301 may be a pouch cell, where rather than using a metallic cylinder and glass-to-metal electrical feed-through for insulation, conductive foil tabs welded to the electrodes and sealed to the pouch carry the positive and negative terminals to the outside. The pouch cell offers a simple, flexible and lightweight solution to battery design, and allows some expansion in the z-direction due to the ability to expand slightly, but is less forgiving with x-y expansion. For at least this reason, it is desirable to limit expansion overall, but for any expansion that does occur, it is desirable to configure expansion in the z-direction primarily and restrict it in the x-y directions. In this example, a formation process with a high charge rate, 4 C-7 C+, for example, may be utilized configuring the expansion in the anode to be higher in the z-direction while being less in the x-y directions.

Alternatively, the cell 301 may comprise a stacked prismatic cell, where layers of anode and cathodes are sandwiched in a metal enclosure. If the metal enclosure is very close to the electrodes in the z-direction but with space in the x-y directions, the expansion may be configured with a formation process that comprises a low charge rate, such as 0.4 C, for example, resulting in less z-expansion and higher x/y-expansion.

This configuration of the anode expansion may be utilized for any cell packaging type, whether it be a pouch cell, a prismatic cell, or a cylindrical cell with a spiral arrangement of the electrodes. In the spiral configuration, the x-y expansion of the very long electrodes, ˜ centimeters long, can be significant if not controlled, so a low x-y expansion may be desired in this case with high charge rate formation.

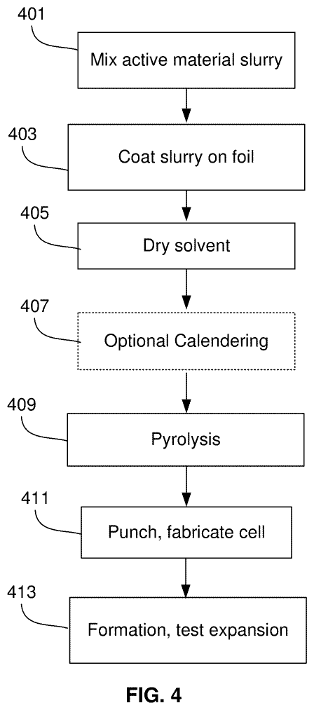

FIG. 4 is a flow diagram of a process for configured expansion in a silicon anode, in accordance with an example embodiment of the disclosure. While one process to fabricate composite electrodes comprises a high-temperature pyrolysis of an active material on a substrate coupled with a lamination process, this process comprises physically mixing the active material, conductive additive, and binder together, and coating it directly on a current collector. This example process comprises a direct coating process in which an anode slurry is directly coated on a copper foil using a binder such as CMC, SBR, Sodium Alginate, PAI, PI and mixtures and combinations thereof.

In step 401, the raw electrode active material may be mixed using a binder/resin (such as PI, PAI), solvent, and conductive carbon. For example, graphene/VGCF (1:1 by weight) may be dispersed in NMP under sonication for, e.g., 45-75 minutes followed by the addition of Super P (1:1:1 with VGCF and graphene) and additional sonication for, e.g., 45-75 minutes. Silicon powder with a desired particle size, may then be dispersed in polyamic acid resin (15% solids in N-Methyl pyrrolidone (NMP)) at, e.g., 900-1100 rpm in a ball miller for a designated time, and then the conjugated carbon/NMP slurry may be added and dispersed at, e.g., 1800-2200 rpm for another predefined time to achieve a slurry viscosity within 2000-4000 cP and a total solid content of about 30%. The particle size and mixing times may be varied to configure the active material density and/or roughness.

In step 403, the slurry may be coated on the foil at a loading of, e.g., 3-4 mg/cm², which may undergo drying in step 405 resulting in less than 15% residual solvent content. In step 407 an optional calendering process may be utilized where a series of hard pressure rollers may be used to finish the film/substrate into a smoothed and denser sheet of material. Calendering may cause increased z-direction expansion, while x-y expansion is not affected, but even by incorporating a calendaring process, the expansion is generally not more than would be if there had been no calendering.

In step 409, the active material may be pyrolyzed by heating to 500-800 C such that carbon precursors are partially or completely converted into glassy carbon. The pyrolysis step may result in an anode active material having silicon content greater than or equal to 50% by weight, where the anode has been subjected to heating at or above 400 degrees Celsius. Pyrolysis can be done either in roll form or after punching in step 411. If done in roll form, the punching is done after the pyrolysis process. The punched electrode may then be sandwiched with a separator and cathode with electrolyte to form a cell. In step 413, the cell may be subjected to a formation process, comprising initial charge and discharge steps to lithiate the anode, with some residual lithium remaining. The formation charge rate may be utilized to configure the resulting anode expansion, where a higher charge rate, such as 4 C, 7 C, 1 C, etc., a lower x-y expansion and higher z-expansion may result, while a lower C rate formation, such as 0.2 C. 0.4 C, etc., may result in a low z-direction anode expansion with a higher x-y direction anode expansion. The expansion of the anode may be measured to confirm the desired expansion, e.g., little x-y expansion and primarily z-direction expansion or little z-direction expansion and primarily x-y expansion.

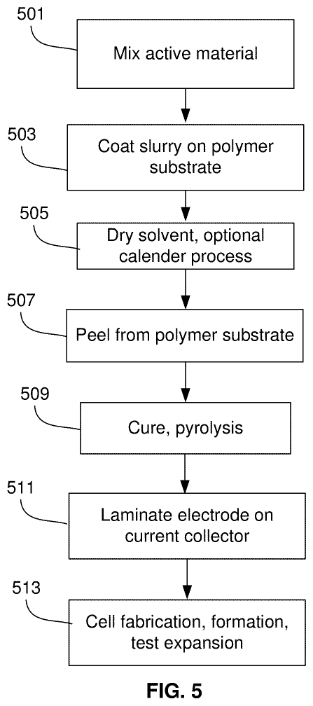

FIG. 5 is a flow diagram of an alternative process for configuring expansion in a silicon anode, in accordance with an example embodiment of the disclosure. While the previous process to fabricate composite anodes employs a direct coating process, this process physically mixes the active material, conductive additive, and binder together coupled with peeling and lamination processes.

This process is shown in the flow diagram of FIG. 5, starting with step 501 where the active material may be mixed with a binder/resin such as polyimide (PI) or polyamide-imide (PAI), solvent, the silosilazane additive, and optionally a conductive carbon. As with the process described in FIG. 4, graphene/VGCF (1:1 by weight) may be dispersed in NMP under sonication for, e.g., 45-75 minutes followed by the addition of Super P (1:1:1 with VGCF and graphene) and additional sonication for, e.g., 45-75 minutes. Silicon powder with a desired particle size, may then be dispersed in polyamic acid resin (15% solids in N-Methyl pyrrolidone (NMP)) at, e.g., 800-1200 rpm in a ball miller for a designated time, and then the conjugated carbon/NMP slurry may be added and dispersed at, e.g., 1800-2200 rpm for, e.g., another predefined time to achieve a slurry viscosity within 2000-4000 cP and a total solid content of about 30%. The particle size and mixing times may be varied to configure the active material density and/or roughness.

In step 503, the slurry may be coated on a polymer substrate, such as polyethylene terephthalate (PET), polypropylene (PP), or Mylar. Alternatively, the slurry may be tape casted without a need for a substrate. The slurry may be coated on the PET/PP/Mylar film at a loading of 3-4 mg/cm² (with 15% solvent content), and then dried to remove a portion of the solvent in step 505. An optional calendering process may be utilized where a series of hard pressure rollers may be used to finish the film/substrate into a smoother and denser sheet of material. Calendering may cause increased z-direction expansion, while x-y expansion is not affected, but even by incorporating a calendaring process, the expansion is not more than would be if there had been no calendering.

In step 507, the green film may then be removed from the PET, where the active material may be peeled off the polymer substrate, the peeling process being optional for a polypropylene (PP) substrate, since PP can leave ˜2% char residue upon pyrolysis. No peeling is required when tape casting is used. The peeling may be followed by a cure and pyrolysis step 509 where the film may be cut into sheets, and vacuum dried using a two-stage process (100-140° C. for 12-16 hour, 200-240° C. for 4-6 hours). The dry film may be thermally treated at 800-1200° C. to convert the polymer matrix into carbon. The pyrolysis step may result in an anode active material having silicon content greater than or equal to 50% by weight, where the anode has been subjected to heating at or above 400 degrees Celsius.

In step 511, the pyrolyzed material may be flat or roll press laminated on the current collector, where a copper foil may be coated with polyamide-imide with a nominal loading of 0.45 mg/cm² (applied as a 6 wt % varnish in NMP, dried 14-18 hours at 100-120° C. under vacuum). The silicon-carbon composite film may be laminated to the coated copper using a heated hydraulic press (40-60 seconds, 250-350° C., and 3500-3500 psi), thereby forming the finished silicon-composite electrode. In another embodiment, the pyrolyzed material may be roll-press laminated to the current collector.

In step 513, the electrode may then be sandwiched with a separator and cathode with electrolyte to form a cell. The cell may be subjected to a formation process, comprising initial charge and discharge steps to lithiate the anode, with some residual lithium remaining. The formation charge rate may be utilized to configure the resulting anode expansion, where a higher charge rate, such as 4 C, 7 C, 1 C, etc., a reduced x-y expansion and increased z-expansion may result, while a lower C rate formation, such as 0.20. 0.4 C, etc., may result in a low z-direction anode expansion with a higher x-y direction anode expansion. The expansion of the anode may be measured to confirm reduced expansion and anisotropic nature of the expansion. The larger silicon particle size results in a rougher surface, higher porosity and less dense material, which reduces the expansion of the active material during lithiation.

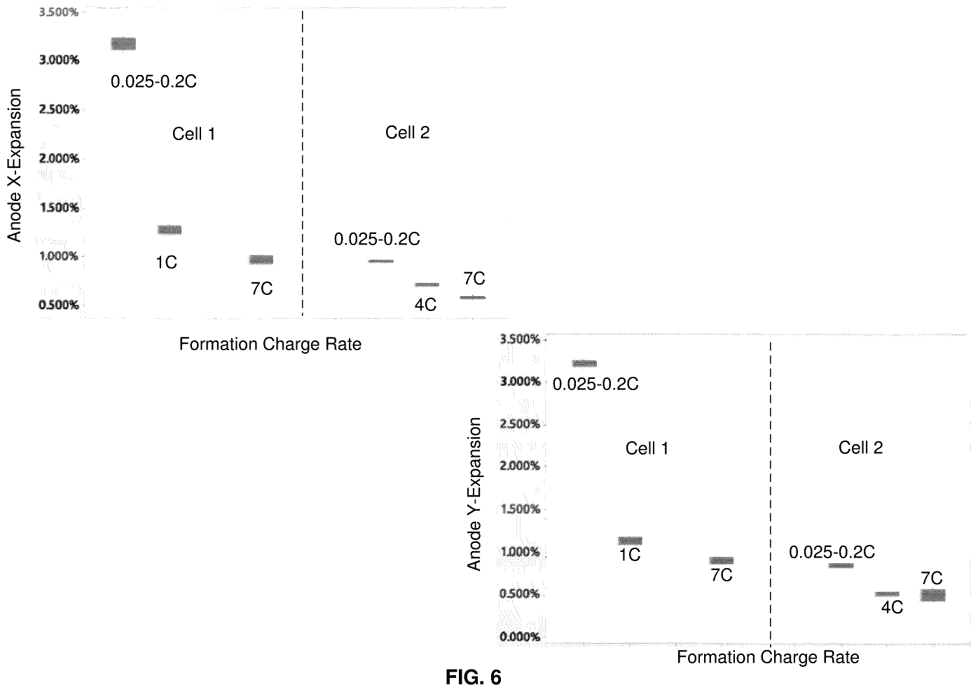

FIG. 6 illustrates expansion of various anodes for different formation charge rates, in accordance with an example embodiment of the disclosure. Referring to FIG. 6, there is shown a plot of x-direction expansion and a plot of y-direction expansion. In each plot, there is two cell designs. The anodes may each comprise a silicon carbon composite with silicon >80% and laminated to copper foil current collectors of 6-20 μm thickness. For Cell 1, 5-layer stacked prismatic cells may be prepared with each cell containing 6 pieces of an anode paired with 5 pieces of a cathode comprised of 92% lithium nickel manganese cobalt oxide (NCM) 811, 4% PVdF, and 4% conductive carbon additive coated on 15 μm thick aluminum foil. The separator consisted of a polyolefin base layer coated with a polymer blend. The electrolyte solution comprises LiPF₆ dissolved in a mixture of organic carbonates. The cells may be clamped between steel plates with a pressure of 140 psi and charged with an initial rate ranging from 0.33 C to 7 C. These cells demonstrate a nominal capacity of 940 mAh.

For Cell 2, 5-layer stacked prismatic cells were prepared with each cell containing 6 pieces of an anode paired with 5 pieces of a cathode comprised of 95% NCM622, 2.5% PVdF, and 2.5% conductive carbon additive coated on 15 μm thick aluminum foil. The separator may comprise a polyolefin base layer coated with a polymer blend. The electrolyte solution may comprise LiPF₆ dissolved in a mixture of organic carbonates. The cells may be clamped between steel plates with a pressure of 140 psi and charged with an initial rate ranging from 0.33 C to 7 C. These cells demonstrate a nominal capacity of 710 mAh.

For both cells, a faster formation rate results in lower x-y expansion, as shown by the decreasing expansion measurements for anodes with higher formation rates. This demonstrates the ability to configure anode expansion of silicon-dominant anodes via the formation process. Similar expansion numbers are possible with thicker foils, such as 10 μm or more, but the use of formation to configure expansion while still using thinner foils may reduce material costs. Since formation initiates the first expansion and SEI layer growth of silicon, tuning the formation charge rate to optimize different phenomena, such as SEI composition, thickness, and homogeneity on the anode can improve cell performance and cycle life. In addition, the use of the formation process disclosed here can result in configured expansion during operation of the cell.

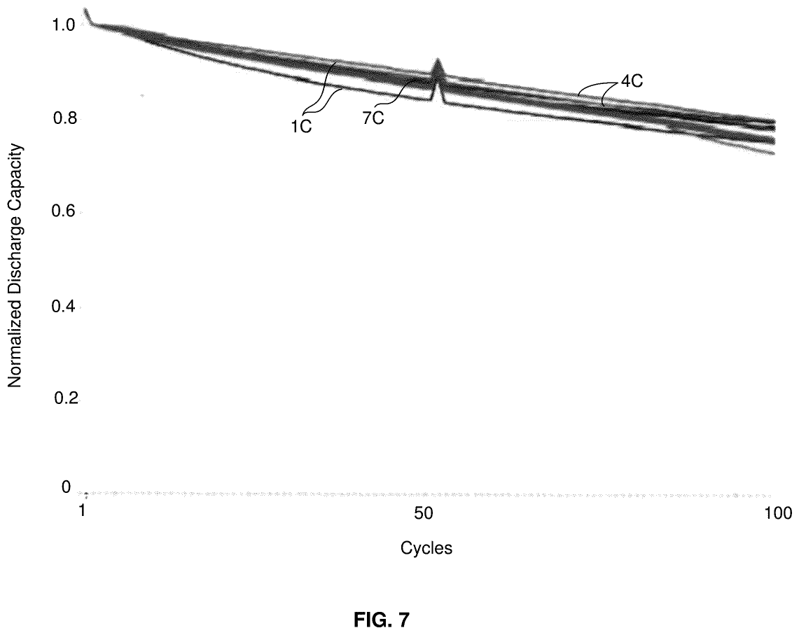

FIG. 7 illustrates discharge capacity during cycling of cells with different formation rates, in accordance with an example embodiment of the disclosure. Referring to FIG. 7, there is shown normalized discharge capacity versus the number of cycles for cells with 1C, 4C, and 7C formation charge rates. For testing cycle life, the cells may be cycled between 4.1 V and 2.75 V with a discharge rate of 0.5 C and a discharge rate of 0.2 C every 50^{th} cycle. As can be seen from the plot, very little difference is shown for the cells with different formation charge rates out to 100 cycles, indicating that anode expansion may be configured utilizing formation without affecting cycle life.

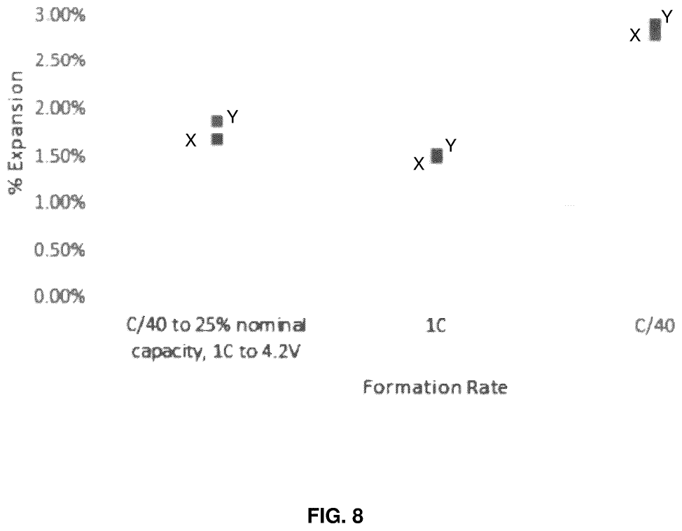

FIG. 8 illustrates expansion rates for anodes subjected to different formation processes, in accordance with an example embodiment of the disclosure. Referring to FIG. 8, there is shown the amount of expansion for anodes subjected to formation processes with a 1C rate, a C/40 rate, and a hybrid low/high formation charge rate. As expected, the 1C formation demonstrates the least expansion and the C/40 formation rate results in the most expansion, but the hybrid formation with a C/40 rate up to 25% of nominal capacity and then finishing with 1C rate up to 4.2 V also demonstrates a reduced x-y expansion.

The use of higher or hybrid formation rates enables the use of thinner current collectors, which decreases costs and increases energy density of the cell. In addition, faster formation rates enable faster manufacturing times and thus higher throughput, without compromise in cycling performance.

In an example embodiment of the disclosure, a method and system are described for high speed formation of cells for configuring anisotropic expansion of silicon-dominant anodes. The battery may comprise a cathode, an electrolyte, and an anode, where the anode may comprise a current collector and an active material on the current collector. An expansion of the anode may be configured by a charge rate during formation of the battery. The expansion of the anode may be lower than 1.5% in lateral dimensions perpendicular to a thickness of the anode for higher charge rates during formation where the active material comprises more than 50% silicon. The higher charge rates may comprise 1C or higher.

The expansion of the anode may be higher in lateral dimensions perpendicular to a thickness of the anode for charge rates below 1C during formation. The expansion of the anode may be lower in lateral dimensions for thicker current collectors. Thicker current collectors may be 10 μm or thicker. The expansion of the anode may be lower in lateral dimensions for more rigid materials for the current collector. A more rigid current collector may comprise nickel and a less rigid current collector may comprise copper. The expansion of the anode may be more anisotropic if the active material is roll press laminated to the current collector and the expansion of the anode may be less anisotropic if the active material is flat press laminated to the current collector.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations. As utilized herein, a battery, circuitry or a device is “operable” to perform a function whenever the battery, circuitry or device comprises the necessary hardware and code (if any is necessary) or other elements to perform the function, regardless of whether performance of the function is disabled or not enabled (e.g., by a user-configurable setting, factory trim, configuration, etc.).

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

1. A battery, the battery comprising:
a cathode, an electrolyte, and an anode, the anode comprising:
a current collector; and
an active material on the current collector, wherein an expansion of the anode is configured by a charge rate during formation of the battery.

2. The battery according to claim 1, wherein the expansion of the anode is less than 1.5% in lateral dimensions perpendicular to a thickness of the anode for higher charge rates during formation and the active material comprises >50% silicon.

3. The battery according to claim 1, wherein the higher charge rates are 1C or higher.

4. The battery according to claim 1, wherein the expansion of the anode is higher than 1.5% in lateral dimensions perpendicular to a thickness of the anode for charge rates below 1C during formation and the active material comprises >50% silicon.

5. The battery according to claim 1, wherein the expansion of the anode is lower in lateral dimensions for thicker current collectors.

6. The battery according to claim 5, wherein thicker current collectors are 6 μm or thicker.

7. The battery according to claim 1, wherein the expansion of the anode is lower in lateral dimensions for more rigid materials for the current collector.

8. The battery according to claim 7, wherein a more rigid current collector comprises nickel and a less rigid current collector comprises copper.

9. The battery according to claim 1, wherein the expansion of the anode is more anisotropic if the active material is roll press laminated to the current collector.

10. The battery according to claim 1, wherein the expansion of the anode is less anisotropic if the active material is flat press laminated to the current collector.

11. A method of forming a battery, the method comprising:
forming a battery comprising a cathode, an electrolyte, and an anode, the anode comprising a current collector and an active material on the current collector; and
configuring an expansion of the anode utilizing a charge rate during formation of the battery.

12. The method according to claim 11, wherein the expansion of the anode is less than 1.5% in lateral dimensions perpendicular to a thickness of the anode for higher charge rates during formation and wherein active material comprises >50% silicon.

13. The method according to claim 11, wherein the higher charge rates are 1C or higher.

14. The method according to claim 11, wherein the expansion of the anode is higher than 1.5% in lateral dimensions perpendicular to a thickness of the anode for charge rates below 1C during formation and wherein the active material comprises >50% silicon.

15. The method according to claim 11, wherein the expansion of the anode is lower in lateral dimensions for thicker current collectors.

16. The method according to claim 15, wherein thicker current collectors are 6 μm or thicker.

17. The method according to claim 11, wherein the expansion of the anode is lower in lateral dimensions for more rigid materials for the current collector.

18. The method according to claim 17, wherein a more rigid current collector comprises nickel and a less rigid current collector comprises copper.

19. The method according to claim 11, wherein the expansion of the anode is more anisotropic if the active material is roll press laminated to the current collector and is less anisotropic if the active material is flat press laminated to the current collector.

20. A battery, the battery comprising:
a cathode, an electrolyte, and an anode, the anode comprising:
a current collector; and
an active material on the current collector, wherein an expansion of the anode is configured by a charge rate during formation of the battery, said charge rate being less than 1C initially up to less than 50% of a capacity of the battery and then increasing above 1C to complete the formation.
